(19) United States
(12) Patent Application Publication
(10) Pub. No.: US 2020/0093583 A1
(43) Pub. Date: Mar. 26, 2020

(54) OCCLUSION RECORDING INSTRUMENT AND ARTICULATOR

(71) Applicant: Eiji Yamaguchi, Sendai-shi, Miyagi (JP)

(72) Inventor: Eiji Yamaguchi, Sendai-shi, Miyagi (JP)

(21) Appl. No.: 16/620,024

(22) PCT Filed: Mar. 30, 2018
(86) PCT No.: PCT/JP2018/013595

§ 371 Date: Dec. 6, 2019

(30) Foreign Application Priority Data
Jun. 9, 2017 (JP) 2017-114043

(51) Int. Cl. A61C 19/05; A61C 19/045; A61C 11/00

(52) U.S. Cl. CPC A61C 19/05; A61C 11/006; A61C 19/045

(57) ABSTRACT

Provided is an instrument capable of performing maxillomandibular registration after an occlusal vertical dimension is accurately registered in the oral cavity of a patient. With the use of these instruments in the oral cavity, maxillomandibular registration can be performed and a prosthesis can be produced in a state where occlusal stability is reproduced by point contact. Further, with the use of an articulator capable of reproducing the shape and movement of the mandible, a prosthesis can be produced regardless of the experience of the operator.

### TECHNICAL FIELD

The present invention relates to an occlusion recording instrument, a method for using this instrument, and an articulator.

### BACKGROUND ART

In the case where a tooth is lost due to dental caries, periodontitis or the like, the tooth is replaced by a prosthesis, such as a crown, a denture or an implant, through treatment. However, an occlusion defect caused by prosthetic treatment, such as misfit of the denture, for example, is also a major problem.

It has begun to be generally recognized that occlusion, that is so-called biting, is important for the health of the whole body. It is known that the occlusion defects cause not only symptoms of serious temporomandibular disorders, such as non-opening of the mouth or having pain or numbness in the jaw, but also various physical disorders, such as shoulder-stiffness, headaches or vertigo, for example. Accordingly, it is considered necessary to accurately perform maxillomandibular registration during prosthetic treatment.

In terms of anatomy, maxillomandibular registration means to register the position of the mandible with respect to the maxilla having a fixed position, that is, to register the position of the mandible with respect to the maxilla in the centric occlusion. In treatment for a missing tooth, impression taking, which uses an impression material, is performed by a dentist, and a working cast is made based on this impression and, thereafter, maxillomandibular registration is performed using wax or the like so as to determine the correct biting position. Accordingly, it is necessary that maxillomandibular registration is accurately performed at a dental clinic, and the occlusion situation of a patient is accurately communicated to a dental technician to produce a prosthesis.

Occlusion states significantly differ with every clinical case depending on presence or absence of natural teeth (remaining teeth), the state of the temporomandibular joint or the like. Accordingly, performing maxillomandibular registration requires skill and experience of the operator and hence, it is extremely difficult to accurately perform the maxillomandibular registration. A dentist performs maxillomandibular registration by an maxillomandibular registration method which he/she considers to be optimal, and a dental technician produces a prosthesis by correcting any errors or deviations brought about by experience of the operator. However, usually, after a prosthesis is produced, the prosthesis is corrected several times in the oral cavity of a patient and, then, the prosthesis is ultimately mounted on the patient. That is, it is difficult to say that maxillomandibular registration is accurately performed in the current state.

Conventionally, there have been proposed a method, a maxillomandibular registration instrument and an articulator for accurately performing maxillomandibular registration regardless of skill or experience of the operator (for example, Patent Literatures 1 to 4). However, none of the cases eliminate or shorten a time required for correcting a prosthesis in the oral cavity of a patient after the prosthesis is produced.

### CITATION LIST

### Patent Literature

Patent Literature 1: Japanese Patent Laid-Open No. 2005-261510
Patent Literature 2: Japanese Patent Laid-Open No. 2005-152106
Patent Literature 3: Japanese Patent Laid-Open No. 2013-031525
Patent Literature 4: Japanese Patent Laid-Open No. 2015-089375

### SUMMARY OF INVENTION

### Technical Problem

It is an object of the present invention to provide maxillomandibular registration based on a new theory, an occlusion recording instrument capable of easily performing maxillomandibular registration based on this theory, a maxillomandibular registration method which uses the occlusion recording instrument and, further, an articulator suitably used for producing a prosthesis.

### Solution to Problem

The present invention relates to an occlusal recording instrument that records occlusion and an articulator for producing a prosthesis.
(1) An occlusion recording instrument which performs maxillomandibular registration after an occlusal vertical dimension is determined, wherein the occlusion recording instrument is made of a hard material, the occlusion recording instrument has a length of a mesiodistal distance which requires prosthetic treatment, and the occlusion recording instrument has a flat plate shape, or equips a protruding portion.
(2) The occlusion recording instrument according to (1), wherein the occlusion recording instrument having the flat plate shape is configured such that an occlusal vertical dimension is adjustable by selecting a thickness of the occlusion recording instrument or by making the occlusion recording instruments overlap with each other, and the occlusion recording instrument equipping the protruding portion is configured such that an occlusal vertical dimension is adjustable by machining the protruding portion, or by adding a resin.
(3) The occlusion recording instrument according to (1) or (2), wherein the occlusion recording instrument is capable of being cut corresponding to a mesiodistal distance which maxillomandibular registration requires.
(4) The occlusion recording instrument according to any one of (1) to (3), further comprising a holding portion configured to be held by an articulating paper holder and/or tweezers.
(5) An articulator comprising: an upper bow portion configured to support a maxilla model; a lower bow portion configured to support a mandible model; and a strut configured to support an upper bow, wherein the strut equips an upper bow support portion, which comes into contact with the upper bow portion or the lower bow portion, at an end portion of the strut, the upper bow portion and the lower bow portion equip a receiving portion which comes into contact with the upper bow support portion, the upper bow support portion has a shape imitating a condyle of a patient, the receiving portion has a shape imitating a fossa mandibularis, and the receiving portion is configured to be replaceable corresponding to the shape of the mandible of the patient.
(6) The articulator according to (5), wherein the upper bow portion and lower bow portion are fixed by a pulling spring.
(7) An articulator comprising: an upper bow portion configured to support a maxilla model; a lower bow portion configured to support a mandible model; and a maxilla mounting plate and a mandible mounting plate, wherein the mandible mounting plate is configured to be movable so as to allow the mandible mounting plate to apply movement similar to rotation and pendulum motion defined by Monson's spherical theory.

### Advantageous Effects of Invention

Accuracy of a prosthesis is enhanced and hence, an occlusion defect caused by the prosthesis can be eliminated. Further, after a prosthesis is produced, it is possible to shorten a time required for correcting the prosthesis in the oral cavity of a patient and hence, a burden imposed on the patient can be reduced. Further, with the use of the occlusion recording instrument and the articulator of the present invention, it is possible to produce a proper prosthesis regardless of the experience of the dentist or dental technician.

### BRIEF DESCRIPTION OF DRAWINGS

FIG. 1 is a view showing an example of an occlusion recording instrument.

FIG. 2 is a view showing an example of a method for using an occlusion recording instrument which includes protruding portions.

FIG. 3 is a view showing an example of a method for using the occlusion recording instrument which includes the protruding portions.

FIG. 4 is a view showing an example of the occlusion recording instrument.

FIG. 5 is a view showing an example of the occlusion recording instrument which is used in combination.

FIG. 6 is a view showing an example of the occlusion recording instrument which is used in combination.

FIG. 7 is a view showing an example of the occlusion recording instrument which is used in combination.

FIG. 8 is a view showing an example of an articulator. FIG. 8(A) is a perspective view of the articulator, FIG. 8(B) is a cross-sectional view of a receiving portion, and FIG. 8(C) is a view showing a state where a position check guide is attached to the articulator.

FIG. 9 is a view showing an example of an articulator. FIG. 9(A) is a perspective view of the articulator, and FIGS. 9(B), (C) are views showing the structure of a mandible mounting plate.

### DESCRIPTION OF EMBODIMENTS

A registration instrument disclosed in this specification can cope, regardless of skill and experience of the operator, with maxillomandibular registration and impression taking for crown restoration which are performed in dental prosthetic treatment of any type, such as full mouth treatment, crown bridge treatment, implants or denture treatment.

Conventionally, maxillomandibular registration has been performed, such as maxillomandibular registration using a material deformable by being bitten, such as wax, or maxillomandibular registration using a silicone impression or resin polymerization where a paste is cured. On the other hand, maxillomandibular registration has not been performed which uses a tapping method of a hard material. However, when an occlusal vertical dimension is determined by a tapping method of a hard material and, thereafter, maxillomandibular registration is performed, maxillomandibular registration can be performed in a state where the external pterygoid muscle is active. By performing maxillomandibular registration in a state where the external pterygoid muscle is active, immediate side shift can be inhibited and hence, maxillomandibular registration can be performed in the centric position.

By performing maxillomandibular registration with a simple procedure shown in the following example, a definitive prosthesis can be produced in a state where a jaw position at which a patient can bite most easily is reproduced. This method is equivalent to performing maxillomandibular registration under the same conditions as a definitive prosthesis and hence, maxillomandibular registration can be performed in a state where the terminal hinge axis is reproduced, which has been considered difficult to reproduce with conventional methods.

Note that, in this embodiment, the jaw position refers to the three-dimensional position of the mandible with respect to the maxilla, and defines the contact positional relationship between the maxilla and the mandible which is required at the time of mastication. The maxillary bone is a portion of the skull so that the position of the maxillary bone is fixed. To the contrary, the mandible bone has temporomandibular joints on the left and right sides so that the mandible bone moves not only in the vertical direction but also in the horizontal direction. Further, there are various opinions about the definition of the centric position and hence, in this embodiment it is assumed that “centric position=tapping point (muscular position)=condylar stabilized position”.

What is required for performing maxillomandibular registration in the condylar stabilized position is that, in performing maxillomandibular registration, horizontal positions of upper and lower tooth rows are allowed to freely move even after the upper and lower tooth rows come into contact with each other. When horizontal free movement is allowed, the condyle moves to a certain stable position in the fossa mandibularis without difficulty, that is, to a condylar stabilized position. After the condyle moves, maxillomandibular registration is performed, and a maximal intercuspal position appropriate for such a position is given by artificial teeth. With such operations, the centric occlusion can be determined, and the centric position and the centric occlusion fit each other.

That is, maxillomandibular registration is performed in a position where a horizontal load is set to zero and the temporomandibular joint can bite most easily (condylar stabilized position=centric position=physiological occlusion), and prosthetic treatment is performed, such as arranging artificial teeth in such a position so as to give the maximal intercuspal position (centric occlusion=prosthetic occlusion). With such operations, the centric position and the centric occlusion fit each other. However, a method and an instrument which performs maxillomandibular registration in this manner do not exist as yet. The present invention relates to an instrument which can perform maxillomandibular registration in a state where the centric position and the centric occlusion are made to fit each other. The present invention also relates to an articulator which can provide long centric and wide centric between the centric position and the centric intercuspal position.

Hereinafter, an occlusion recording instrument will be described with reference to drawings. The occlusion recording instrument described with reference to the drawings hereinafter merely forms an example, and the shape or the size of protruding portions, a holding portion and the like may have various variations.

### Embodiment 1

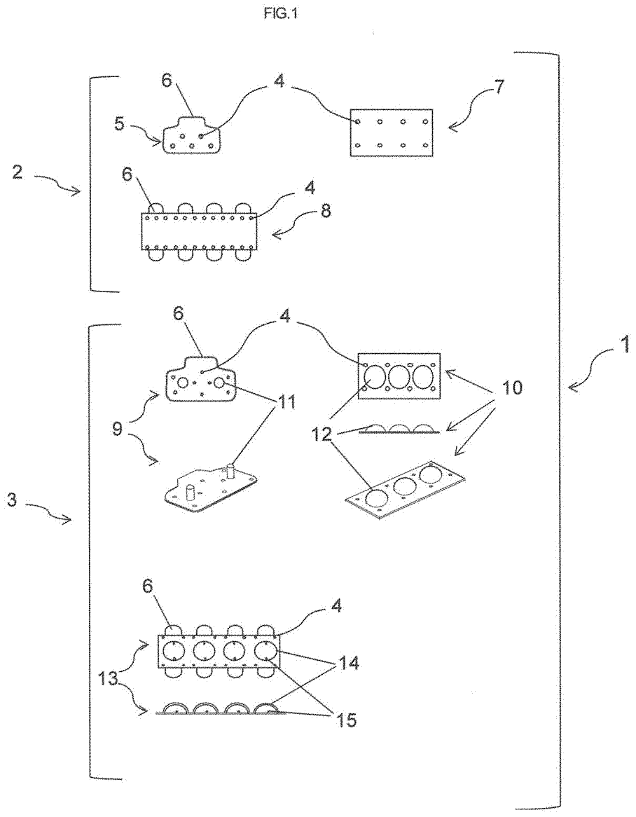

An occlusion recording instrument 1 of the present invention is basically made of a hard material. The occlusion recording instrument 1 is a member having a substantially flat shape, or a shape where a flat member includes protruding portions, or a shape where the flat member includes protruding portions and recessed portions (FIG. 1). Teeth which require maxillomandibular registration may be in various states depending on the state of teeth which require prosthetic treatment, the mode of opposing teeth and the like. Further, the kind of prosthetic treatment to be performed varies depending on a patient and hence, a different appropriate occlusion recording instrument may be used corresponding to the situation. The occlusion recording instrument 1 of the present invention is made of a hard material and hence, maxillomandibular registration can be performed in a state where the external pterygoid muscle is active. Further, the occlusion recording instrument 1 is not broken even when bitten down on by a patient, and is not deformed even when moved to the outside of the oral cavity. Accordingly, maxillomandibular registration can be accurately performed regardless of the skill of the operator.

In the case of a flat occlusion recording instrument 2, any sheet may be used for a hard material provided that the sheet has certain hardness. For example, a material may be used, such as a dental composite resin, an acrylic resin, polycarbonate, polystyrene, polyethylene, polypropylene, polyethylene terephthalate, polyvinyl chloride, an ABS resin, a thick paper/paperboard, a ceramic paper, a watertight paper, a polypropylene film processed paper, or a metal sheet, such as a copper sheet, a zinc sheet, an aluminum sheet, a brass sheet, an iron sheet, a stainless steel sheet, a nickel sheet, a silver sheet, a titanium sheet, or a lead sheet.

In the case of an occlusion recording instrument 3 which includes protruding portions, or protruding portions and recessed portions, a patient is made to bite into the occlusion recording instrument 3 in the oral cavity. When the occlusal vertical dimension is high, the occlusion recording instrument 3 is machined. To the contrary, when the occlusal vertical dimension is low, a quick cure resin is caused to be cured on the upper surface so as to correct the height by increasing the height. Accordingly, it is preferable to manufacture the occlusion recording instrument 3 using a dental resin. A dental resin may be a thermoplastic resin used for manufacturing a splint, a denture base or the like, a quick cure resin used for forming a transitional denture or the like, a composite resin (photopolymerization resin) used in filling treatment, an acrylic resin used for manufacturing an artificial tooth, a denture base, a splint or the like, a hard resin used for an artificial tooth or the like. Among these resins, a thermoplastic resin which is also used as a hard sheet for a splint can also be processed to a thickness of 0.3 mm or less. Accordingly, the thermoplastic resin is suitably used for an occlusion recording instrument. Further, the composite resin may be preferably used in performing correction when an occlusal vertical dimension is low.

It is sufficient that the sheet has a thickness of approximately 0.1 to 5.0 mm. In the case of the flat occlusion recording instrument 2, it is sufficient to select the thickness depending on a clearance. When the clearance is large, a sheet having a thickness of approximately 1.0 to 5.0 mm may be used. To the contrary, when the clearance is small, it is sufficient to use a sheet having a thickness of approximately 0.1 to 3.0 mm, more preferably approximately 0.3 to 1.0 mm. Alternatively, an occlusal vertical dimension may be corrected such that sheets having a fixed thickness are prepared, and a plurality of sheets are made to overlap with each other so as to adjust the height. In the case where the sheets are used in an overlapping manner, it is preferable to provide fitting portions so as to allow the overlapping sheets to be fitted without being disengaged. Further, to allow the sheets to be used in a folded state, it is desirable to apply a folding line in advance.

In the case where the thickness of the sheet is larger than 5.0 mm, there may be a case where the thickness of the sheet adversely affects an occlusal vertical dimension when maxillomandibular registration is performed, thus preventing the maxillomandibular registration from being accurately performed. To the contrary, when the thickness of the sheet is thinner than 0.1 mm, depending on the quality of material of a sheet to be used for the occlusion recording instrument 1, the sheet may be deformed or broken when bitten down on by a patient. Accordingly, such a thickness is not preferable. When the thickness of the sheet is 0.3 to 1.0 mm, there is no possibility that the sheet adversely affects an occlusal vertical dimension. Further, there is also no possibility that the sheet is deformed and broken when bitten down on by a patient.

The occlusion recording instrument 1 may be provided with small holes 4 when necessary. By forming the small holes 4 in the occlusion recording instrument 1, an impression material, such as silicone, gel or wax can easily entangle and hence, the impression material is prevented from being easily detached when maxillomandibular registration is performed. The small holes 4 may be provided as appropriate corresponding to the material of an impression material to be used and the occlusion recording instrument 1, and a region which requires maxillomandibular registration.

First, the flat occlusion recording instrument 2 will be described. An occlusion recording instrument 5 includes a holding portion 6. When the occlusion recording instrument is used in the oral cavity, an occlusion state is recorded in the oral cavity of a patient with the holding portion 6 held by an articulating paper holder. Specifically, an impression material is disposed on one surface or both surfaces of the occlusion recording instrument, and a patient is made to bite the impression material to record the occlusion state. The maxillomandibular registration is performed in a state where the patient closes his/her mouth so that it is necessary to hold the holding portion 6 using the articulating paper holder. Accordingly, the holding portion is required to have a thickness which allows the holding portion to be held by the articulating paper holder.

The thickness which allows the holding portion to be held by the articulating paper holder is 5 mm or less, preferably 1 mm or less, and more preferably 0.5 mm or less. Further, although a thickness may change also depending on the material to be used, it is preferable that the holding portion 6 has a thickness of 0.1 mm or more to prevent the change of the shape, such as deflection. Accordingly, when the holding portion is held by the articulating paper holder, it is preferable that the holding portion falls within a range of 0.2 mm or more and 0.5 mm or less.

Further, in the case of examining occlusion by using a working cast, it is sufficient to hold the occlusion recording instrument by tweezers or the hand, and so the size and the thickness of the holding portion may be set to a size and a thickness which allow the holding portion to be easily held by the tweezers or the hand. It is also possible to use an occlusion recording instrument 7 having a shape which does not include an articulating paper holder holding portion. The occlusion recording instrument 7 is not required to be held by the articulating paper holder and hence, a sheet having a larger thickness may also be used.

An occlusion recording instrument 8 is configured to include the holding portions 6 on both sides thereof. The occlusion recording instrument 8 is also configured to be capable of being cut into a required size corresponding to a region where maxillomandibular registration is performed.

The flat-plate-shaped occlusion recording instrument 5, 7, 8 may simultaneously record occlusion of upper and lower teeth by disposing impression materials on both surfaces thereof. Alternatively, the flat-plate-shaped occlusion recording instrument 5, 7, 8 may be directly disposed on a wax rim in the case of a partial denture, thus being used for registering occlusion of an opposing natural tooth. By disposing the occlusion recording instrument made of a hard member on a wax rim, it is possible to reproduce reflex caused by the stimulation of an occlusal pressure generated at the time of mastication. Further, in the case where occlusal correction is directly performed by a wax rim, downward movement may occur during occlusal correction is performed. However, the occlusion recording instrument is made of a hard member and hence, it is unnecessary to worry about the downward movement of an occlusal vertical dimension. Further, it is difficult to produce a flat surface on a wax rim. However, with the use of the flat-plate-shaped occlusion recording instrument 5, 7, 8, the flat surface can be easily produced on the wax rim and hence, accurate maxillomandibular registration can be performed regardless of skill of the operator.

An occlusion recording instrument 9, 10 is an occlusion recording instrument which includes protruding portions. The occlusion recording instrument 9 shown in FIG. 1 is shown in the plan view as viewed from above and the perspective view, and the occlusion recording instrument 10 is shown in the plan view as viewed from above, the side view, and the perspective view. The shape of each protruding portion 11 of the occlusion recording instrument 9 is a cannonball shape, and each protruding portion 12 of the occlusion recording instrument 10 has a dome shape. However, the shape of the protruding portion is not limited to the above, and may be any shape provided that the protruding portion comes into point contact with an opposing natural tooth of a patient. For example, with respect to the cannonball-shaped protruding portions 11 of the occlusal recording instrument 9, protruding portions having different thicknesses and heights are prepared within a range where a diameter is approximately 1 to 6 mm and a height is approximately 2 to 10 mm, and appropriate protruding portions may be selectively used corresponding to the region and the state of a tooth for which the occlusion recording instrument is used, the build of a patient or the like. Further, with respect to the dome-shaped protruding portions 12, protruding portions may be prepared and used which have different diameters and heights within a range where a diameter is approximately 1 to 12 mm and a height is approximately 0.5 to 6 mm. Further, the occlusion recording instrument 10 may be used by being cut corresponding to the region which requires maxillomandibular registration.

Further, an occlusion recording instrument 13 may be used which is not solid so that recessed portions are formed on the rear surface with the formation of protruding portions. In FIG. 1, the occlusion recording instrument 13 is shown in the plan view as viewed from above, and the cross-sectional view taken along the center thereof. The occlusion recording instrument 13 has a structure which includes protruding portions/recessed portions 14. For example, it is possible to simultaneously perform maxillomandibular registration on the protruding portion side and impression taking of abutment teeth on the recessed portion side. The occlusion recording instrument 13 has maintaining holes 15 on the tongue side and the bucca side of the protruding portion/recessed portion 14, and the maintaining holes 15 are provided for releasing air in performing impression taking on the recessed portion side. The occlusion recording instrument 13 also includes the holding portions 6 on both sides, and is configured to be capable of being cut corresponding to a region which requires maxillomandibular registration.

In either case, the holding portion 6 may be provided on one side as in the case of the occlusion recording instrument 5, 9, and may be provided on both sides as in the case of the occlusion recording instrument 8, 13. Alternatively, no holding portion may be provided as in the case of the occlusion recording instrument 7, 10. Further, as shown in the occlusion recording instrument 8, 10, 13, the occlusion recording instrument may be configured such that only a required amount of the occlusion recording instrument is cut and used. Next, the description will be made with respect to an maxillomandibular registration method which uses the occlusion recording instrument.

### EXAMPLE 1

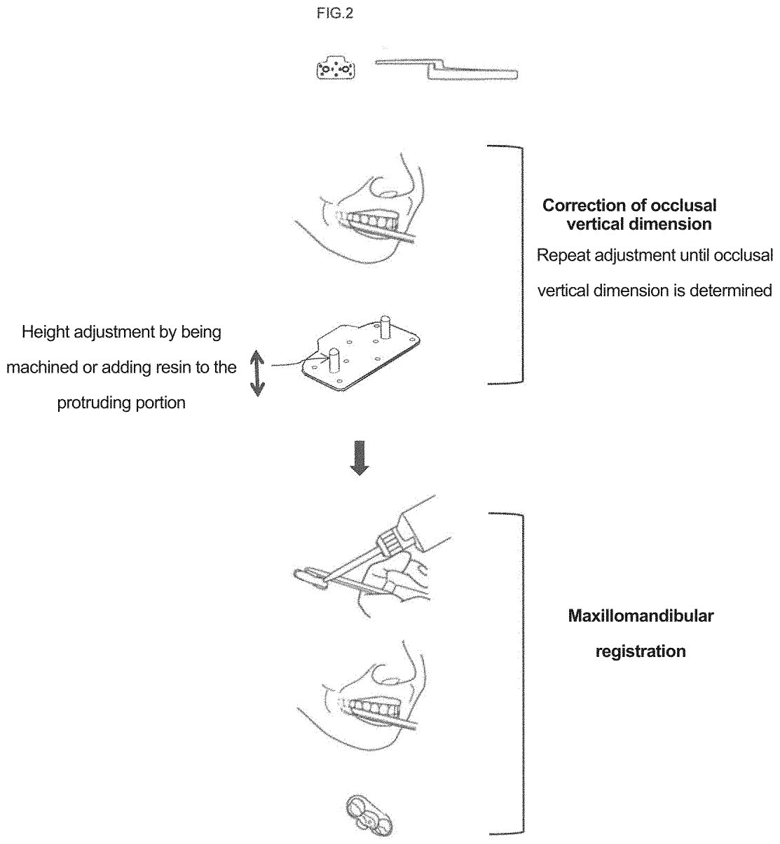

The description will be made with respect to a method for performing maxillomandibular registration using the occlusion recording instrument 9 in the oral cavity by taking a case a patient whose right lower molar is missing as an example (FIG. 2). In a state where an occlusion recording instrument is pinched by an articulating paper holder, a patient is made to bite into the occlusion recording instrument in the oral cavity of the patient to check whether or not an occlusal vertical dimension is proper. When the height is large, the protruding portions of the occlusion recording instrument are machined. To the contrary, when the height is small, a resin is added to the protruding portions. Then, the patient is made to check the occlusal vertical dimension again in the oral cavity of the patient. Until the occlusal vertical dimension becomes a proper height, such operations are repeated to determine the occlusal vertical dimension (FIG. 2, correction of occlusal vertical dimension).

After the occlusal vertical dimension is determined, an impression material is disposed on the occlusion recording instrument, and the patient is made to bite into the impression material to perform maxillomandibular registration (FIG. 2, maxillomandibular registration). Maxillomandibular registration which is ultimately performed records the horizontal relationship with respect to the opposing natural teeth after the height is corrected. Accordingly, the maxillomandibular registration is equivalent to recording occlusion in a state where the terminal hinge axis is reproduced. Therefore, it is almost unnecessary to perform correction in mounting a produced prosthesis in the oral cavity of the patient.

When the occlusion recording instrument which equips the protruding portions is used, as described above, an occlusal vertical dimension is corrected by machining the protruding portions or by adding a resin in the oral cavity of the patient and, thereafter, maxillomandibular registration is performed. Accordingly, maxillomandibular registration can be accurately performed regardless of skill of the operator. Correction of an occlusal vertical dimension can be performed over a sufficient time at an initial state and hence, even an inexperienced operator can correct the occlusal vertical dimension with certainty. Further, the occlusion recording instrument is made of a hard material and hence, a sensation similar to a sensation obtained at the time of actually biting with teeth can be reproduced for the patient whereby the appropriate position can be communicated to the operator.

Note that depending on the shape of remaining teeth, there may be a case where it is preferable to use a flat-plate-shaped occlusion recording instrument which equips no protruding portion. In such a case, by selecting the thickness of the flat-plate-shaped occlusion recording instrument to be used, the occlusal vertical dimension can be corrected. Accordingly, flat-plate-shaped occlusion recording instruments having different thicknesses are prepared. Alternatively, a plurality of flat-plate-shaped occlusion recording instruments having the same thickness may be used in an overlapping manner. Also in the case where the flat-plate-shaped occlusion recording instrument is used, the same procedure is performed where the occlusal vertical dimension is determined and, thereafter, maxillomandibular registration is performed.

### EXAMPLE 2

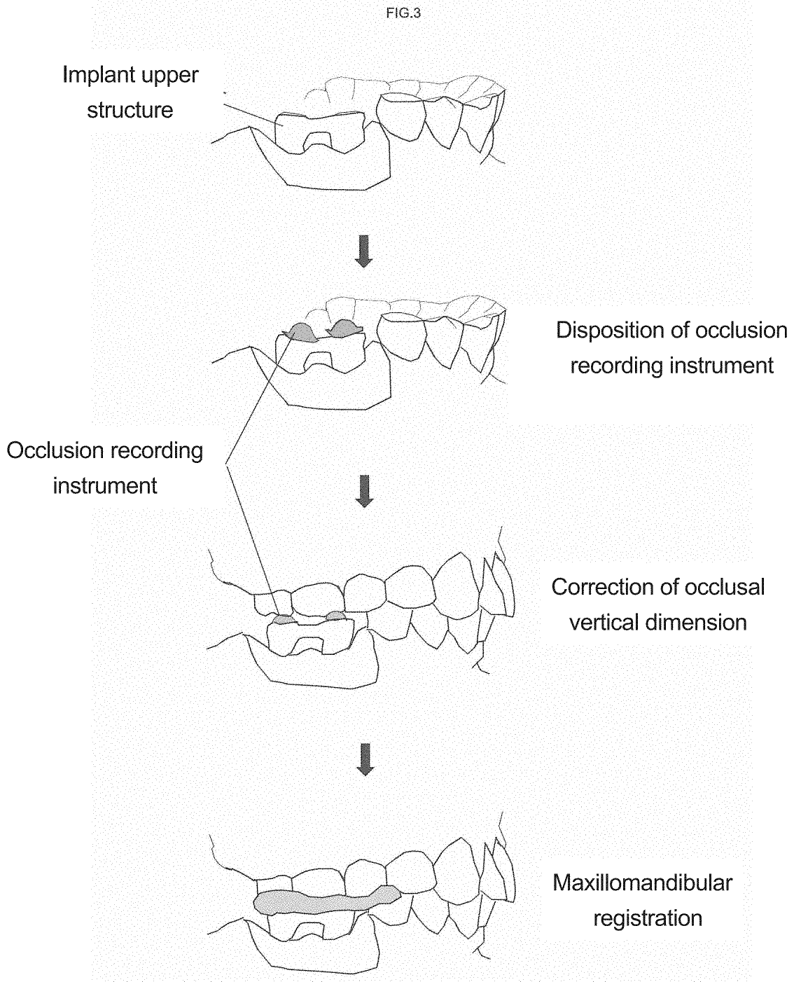

Next, a method for using the occlusion recording instrument 10 which equips dome-shaped protruding portions will be described by taking implants as an example (FIG. 3). In a usual implant treatment, an upper structure is engaged with an implant abutment portion and, thereafter, molding and trial of an artificial tooth are performed. However, the upper surface of the upper structure is substantially flat so that even when maxillomandibular registration is performed in this state, the relationship between an opposing remaining tooth and the artificial tooth to be mounted is not reflected.

In view of the above, after the upper structure is mounted, a dome-shaped occlusion recording instrument is installed on the upper structure. In this embodiment, the occlusion recording instrument is disposed on the upper structure in a state where the occlusion recording instrument is cut into pieces each including one protruding portion 12 of the occlusion recording instrument 10 (FIG. 3, disposition of occlusion recording instrument).

In this state, biting is checked on the working cast, and the occlusal vertical dimension is determined such that the occlusion recording instrument has an appropriate height (FIG. 3, correction of occlusal vertical dimension). The occlusal vertical dimension is corrected by machining the protruding portion or by adding a resin in the same manner as the example 1.

After the occlusal vertical dimension is determined, maxillomandibular registration is performed using an impression material to record the relationship with respect to the opposing teeth (FIG. 3, maxillomandibular registration). Due to such procedure, maxillomandibular registration can be performed in a state where the terminal hinge axis is reproduced. This embodiment shows an example where the occlusal vertical dimension is determined on a working cast, and the maxillomandibular registration is performed. However, maxillomandibular registration may also be performed in the oral cavity of a patient by the similar operations.

As shown in this example, the occlusion recording instrument which equips the protruding portions is disposed on the implant upper structure, and an occlusal vertical dimension is determined and, thereafter, maxillomandibular registration is performed. With such operations, maxillomandibular registration is performed more accurately and hence, it is almost unnecessary to perform correction after an artificial tooth is mounted.

### Embodiment 2

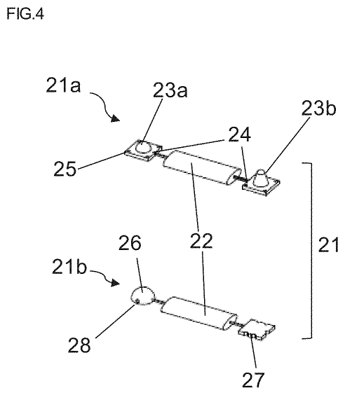

Next, variations of an occlusion recording instrument for implant will be described. An occlusion recording instrument 21 for implant may be configured to have a shape where a holding portion is added to a dome-shaped protruding portion and a flat plate member as described above (FIG. 4). The dome-shaped protruding portion is allowed to come into contact with a flat surface, and the flat plate member is allowed to come into contact with opposing teeth by point contact and hence, maxillomandibular registration can be performed in a state where occlusal stability is reproduced. An occlusion recording instrument 21a equips protruding portions 23a, 23b having different heights on both sides of a holding portion 22. An occlusion recording instrument is prepared which has a shape where the protruding portions have height of 0.3 mm or more and 12 mm or less, more preferably 0.5 mm or more and 8 mm or less, and the occlusion recording instrument includes the protruding portions having different heights on both ends thereof. Further, the occlusion recording instrument 21 may be used for splint treatment for temporomandibular disorders to be used for correcting a height. In the case where the occlusion recording instrument is used for splint treatment for temporomandibular disorders, an occlusion recording instrument having a small thickness is prepared where the protruding portions have a height of approximately 0.1 mm to 0.4 mm. An instrument which includes protruding portions having appropriate heights is selected for the occlusion recording instrument 21a, and the instrument is disposed on the upper structure or a fixture in the oral cavity of a patient, and an occlusal vertical dimension is determined. Further, the protruding portions 23a, 23b are solid so that the occlusal vertical dimension can also be corrected by machining the protruding portions.

The flat plate portions 24 are designed to have the protruding portions 23a, 23b thereon, thus having a large contact area with the upper structure. Small holes 25 are formed at four corners of each flat plate portion 24 in a penetrating manner so that the flat plate portion 24 is prevented from being easily disengaged when caused to adhere by a resin or wax. After the occlusion recording instrument 21 is caused to adhere, the occlusion recording instrument 21 may be cut at a thin portion thereof disposed at the end portion of the holding portion 22.

Further, an occlusion recording instrument 21b is configured to include a dome-shaped protruding portion/recessed portion 26 on one side thereof, and include a flat plate member 27 on the other side thereof. The protruding portion/recessed portion 26 has a structure where the protruding portion/recessed portion 26 has a dome shape, but is recessed when viewed from the lower surface, thus having the shape of a recessed portion. For the protruding portion/recessed portion 26, protruding portion/recessed portions each of which includes a protruding portion having a different height are prepared so that an appropriate protruding portion/recessed portion is selected. Thereafter, a quick cure resin is filled in the protruding portion/recessed portion, and is caused to adhere to an abutment. The protruding portion/recessed portion 26 is designed to have a maintaining hole 28 on the side surface thereof, thus allowing excess quick cure resin to be discharged from the side surface. The flat plate member 27 is a member which is used when an occlusal vertical dimension is small. Plural kinds of flat plate members having a thickness of 0.1 mm or more and 6.0 mm or less, more preferably, 0.5 mm or more and 3.0 mm or less, are prepared. Slits are formed on the periphery of the flat plate member to prevent a resin or wax from being detached due to entanglement. In this embodiment, to have a shape which prevents a resin or wax from being easily detached, small holes, wedge-shaped slits or the like are formed. However, any shape may be adopted provided that the shape increases contact with a resin or the like.

The shapes of the occlusion recording instrument shown in this embodiment merely form examples, and various variations of the occlusion recording instrument may be considered. For example, the occlusion recording instrument may be an occlusion recording instrument where a protruding portion is provided to only one side of the holding portion, an occlusion recording instrument where the flat plate members 27 having different thicknesses are provided at both ends or the like. The occlusion recording instruments are prepared for allowing the selection of an appropriate instrument depending on a portion where an implant is to be installed or the like. Further, the shape of the holding portion may be devised as appropriate by providing a protruding portion at a cross-shaped holding portion or the like. The shape of the protruding portion is not limited to a dome shape. What is important is to have point contact and hence, the shape of the protruding portion may be the shape of a cone, a triangular pyramid or the like which comes into contact at one point, or the shape of a sphere or the like.

### Embodiment 3

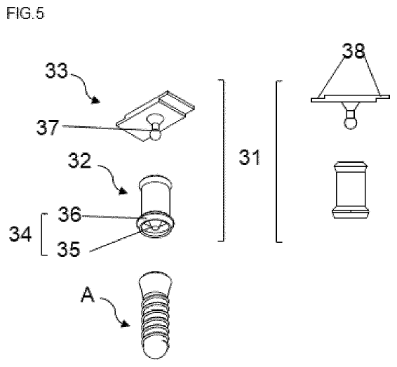

Next, the description will be made with respect to an occlusion recording instrument which is used in a state of being fitted on an implant fixture. FIG. 5 shows the perspective view (on the left side in FIG. 5) and the side view (on the right side in FIG. 5) of an occlusion recording instrument 31. The occlusion recording instrument 31 is formed of a fitting member 32 used in a state of being fitted on a fixture A and a bite plane 33. For the fitting member 32, fitting members having different heights of 3 mm or more and 18 mm or less, more preferably 4 mm or more and 16 mm or less are prepared. Accordingly, a fitting member having an appropriate height can be selected corresponding to the build of a patient and a portion where an implant is to be installed.

For a fixture fitting portion 34 which is disposed at the lower portion of the fitting member 32 and which is fitted on the fixture, members having various shapes are prepared corresponding to the shape of a fixture to be used. To the member shown in FIG. 5, a protrusion 35 is provided which has a shape conforming to a screw insertion portion formed on the upper portion of the fixture. By inserting the protrusion 35 into the screw insertion portion of the fixture, the position with respect to the fixture can be determined. Further, an outer edge portion 36 of the fixture fitting portion 34 has a shape which is allowed to be fitted on the outer edge portion of the upper portion of the fixture. Accordingly, causing the outer edge portion 36 to be fitted on the fixture allows the fitting member 32 to be fixed to the fixture.

The bite plane 33 equips a fitting protrusion 37 on the surface thereof which is fitted on the fitting member 32. A recessed portion (not shown in the drawing) in which the fitting protrusion 37 is fitted is provided to the upper portion of the fitting member 32. Causing the fitting protrusion 37 to be fitted into the recessed portion allows the bite plane 33 to be fixed to the fitting member 32. Also for the bite plane 33, members having different thicknesses of 0.5 mm or more and 10.0 mm or less, more preferably, 1.0 mm or more and 4.0 mm or less are prepared so that a member having an appropriate thickness can be selected. The vertical dimension is determined by the bite plane 33 and the fitting member 32. Accordingly, it is sufficient to select optimum members by comprehensively taking into account the thicknesses and heights of two instruments.

The bite plane 33 equips joint portions 38 on both ends thereof. When an occlusal vertical dimension is determined using a plurality of fixtures, joint portions 38 of adjacent bite planes are caused to adhere and fix to each other by a quick cure resin or the like. Further, when the bite plane and the fitting member are caused to adhere to each other by a quick cure resin or the like so as to form an integral body, an accurate position can be recorded.

Further, depending on the case, the configuration may be adopted where the fitting member 32 having an appropriate height is selected and is fixed to a fixture without using the bite plane 33, and a slight adjustment of a height is performed by machining the fitting member 32, or by adding a resin to the protruding portion when the height is small. The fitting members 32 having different heights are prepared. Accordingly, with the selection of a fitting member having an appropriate height, an occlusal vertical dimension can be determined by slightly adjusting the height. Further, in the case where only the fitting member is used, to accurately determine the positional relationship of the upper structures of the plurality of fixtures, the side portions of the fitting members may be caused to adhere to each other by a rod-shaped or flat-plate-shaped member. Further, when a rod-shaped member is provided to the side surface of each fitting member in advance, the positional relationship between the fitting members can be accurately reproduced by causing the rod-shaped members to adhere to each other by a resin.

### Embodiment 4

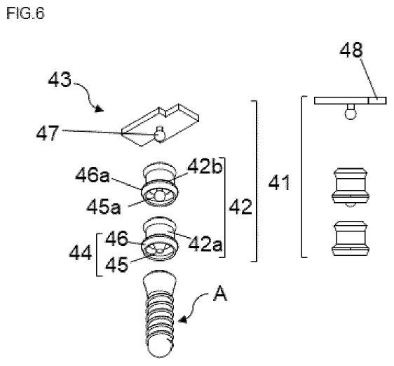

A different mode of the occlusion recording instrument used in a state of being fitted on an implant fixture will be described. The perspective view of an occlusion recording instrument 41 is shown on the left side in FIG. 6, and the side view of the occlusion recording instrument 41 is shown on the right side in FIG. 6. The occlusion recording instrument 41 is used in a state where a plurality of fitting members 42 and a bite plane 43 are combined with each other. In the same manner as the occlusion recording instrument 31 of the embodiment 3, in a fitting member 42a which is to be fitted on a fixture A, a fixture fitting portion 44 equips a protrusion 45 which conforms with the shape of the upper portion of the fixture. Inserting the protrusion 45 into the fixture A allows the position of the fitting member 42a to be determined. Further, an outer edge portion 46 has a shape which is fitted on the outer edge portion of the upper portion of the fixture. Accordingly, causing the outer edge portion 46 to be fitted on the fixture allows the outer edge portion 46 to be fixed to the fixture.

The height of the fitting member 42 is adjusted by fitting a plurality of fitting members to each other. A height adjusting fitting member 42b equips a protrusion 45a and an outer edge portion 46a. A recessed portion (not shown in the drawing) having a shape which corresponds to the protrusion 45a is provided to the side of the fitting member 42a where the fitting member 42a is fitted with the fitting member 42b. Further, causing the outer edge portion 46a to be placed over the upper portion of the fitting member 42a allows the fitting members 42a, 42b to be fitted with each other. In this embodiment, height adjustment is performed by causing two fitting members to be fitted with each other. However, one or more fitting members may be used after a height is adjusted by causing the fitting members to be fitted with the bite plane 43 when needed.

In the same manner as the embodiment 3, the bite plane 43 equips a fitting protrusion 47 on the surface thereof which is fitted on the fitting member 42b. A recessed portion (not shown in the drawing) in which the fitting protrusion 47 is fitted is provided to the upper portion of the fitting member 42b. Causing the fitting protrusion 47 to be fitted in the recessed portion allows the bite plane 43 to be fixed to the fitting member 42b. When the occlusal vertical dimension of a plurality of fixtures is determined, a joint portion 48 provided to the bite plane 43 may be fixed to the joint portion of an adjacent bite plane by a resin or the like. FIG. 6 shows the joint portion 48 having a notched shape. However, provided that the joint portion 48 can join adjacent bite planes, the joint portion 48 may have any shape.

In the embodiments 3, 4, the protrusion is provided on the bite plane side, and the recessed portion which corresponds to the protrusion is provided to the fitting member, and the bite plane and the fitting member are fitted with each other. However, a configuration may be adopted where the recessed portion is provided on the bite plane side, and the protrusion is provided on the fitting member side. Further, a shape may be adopted where the fitting protrusion has a shape having a larger length than the recessed portion formed on the fitting member side, thus allowing a gap to be formed between the bite plane and the fitting member.

### Embodiment 5

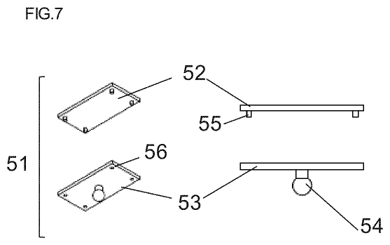

Next, an occlusion recording instrument 51 will be described where wax or a resin is sandwiched between two flat-plate-shaped members to adjust a height. FIG. 7 shows the perspective view (on the left side in FIG. 7) and the side view (on the right side in FIG. 7) of a bite plane 52 and a fixture fitting flat plate member 53. A protrusion 54 which conforms to the shape of a fixture is provided to the lower portion of the fixture fitting flat plate member 53 so that the fixture fitting flat plate member 53 can be fixed to the fixture. In a state where wax or a resin is sandwiched between the bite plane 52 and the fixture fitting flat plate member 53, a patient is made to bite in the oral cavity to determine an occlusal vertical dimension. It is devised that bite plane protrusions 55 are provided on four corners of the bite plane 52, and through holes 56 are provided on four corners of the fixture fitting flat plate member 53 at positions where the through holes 56 are aligned with the bite plane protrusions 55, thus preventing lateral deviation of both members. The height of this member can be adjusted by using wax and hence, an occlusal vertical dimension can be extremely easily determined.

As described in this example, the occlusion recording instrument 1, 21, 31, 41, 51 can be used either in the oral cavity of a patient or on a working cast. Further, the occlusion recording instrument can be used in various prosthetic treatment scenarios, such as a complete denture, a partial denture, implants, a bridge or a splint. It is sufficient to select and use an occlusion recording instrument corresponding to a prosthesis to be produced depending on presence or absence of remaining teeth, the shape of the opposing teeth and the like. With the use of the occlusion recording instrument 1, 21, 31, 41, 51 as pseudo cusp in performing maxillomandibular registration, the lost vertical stop in the oral cavity can be restored. Accordingly, reflex in the oral cavity is recovered while the occlusal correction is performed and hence, accurate maxillomandibular registration can be performed regardless of the experience of the operator. As a result, the occlusal correction in the oral cavity of a patient which is performed after the prosthesis is produced requires only a short time. Further, maxillomandibular registration where reflex in the oral cavity is recovered is performed and hence, there is no possibility that a patient will complain of an occlusion defect after a prosthesis is mounted.

Further, in this embodiment, the example has been shown where the flat-plate-shaped occlusion recording instrument 2 and the occlusion recording instrument 3 equipping the protruding portions are used separately. However, in the case of producing a denture or other cases, two instruments may be used in combination.

Further, also in the case where implant occlusal correction is performed, two kinds of occlusion recording instrument may be used in combination. For example, an occlusal vertical dimension is corrected by the occlusion recording instrument 31 on an implant fixture and, thereafter, the occlusion recording instrument 21a is disposed on the upper portion of the bite plane 33 to perform correction. Accordingly, maxillomandibular registration can be performed by selecting only places with opposing teeth having the best conditions.

Next, an articulator based on a theory of the maxillomandibular registration method shown in this example will be described. With respect to ideal occlusion, researchers of the Gnathology school suggest making the centric position and the centric intercuspal position agree with each other, and it is considered that occlusion where the centric position and the centric intercuspal position agree with each other is ideal occlusion. However, a clear index or procedure for the way to make the centric position and the centric intercuspal position agree with each other does not exist. Accordingly, in the current state, a prosthesis is produced through trial and error for performing clinical treatment.

Two kinds of articulator described hereinafter can reproduce movement where the condyle can freely move, or the rotation and pendulum motion of the mandible, thus automatically applying freedom in centric to a prosthesis.

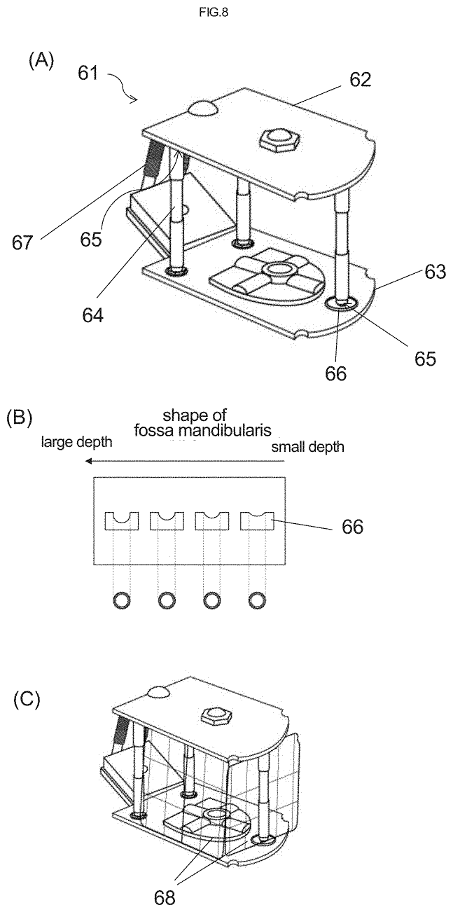

An articulator 61 shown in FIG. 8 equips an upper bow portion 62 and a lower bow portion 63, and has a structure where the upper bow portion 62 is supported by three struts 64. The struts 64 are configured such that the lengths of the struts 64 are correctable in the vertical direction, thus allowing the correction of an occlusal vertical dimension. Further, three upper bow support portions 65, where the struts 64 come into contact with the upper bow portion 62 or the lower bow portion 63, imitate the shape of the condyle. Further, each receiving portion 66 has a shape imitating the fossa mandibularis.

FIG. 8(B) shows the cross-sectional view of the receiving portion 66. For the receiving portion 66, receiving portions having different depths of recesses within a range from a small depth to a large depth are prepared so that the receiving portion 66 may be replaced corresponding to the shape of the fossa mandibularis of a patient. A hole which allows the replacement of the receiving portion 66 by fitting the receiving portion 66 therein is formed in each of the upper bow portion 62 and the lower bow portion 63 so that the receiving portion 66 can be replaced with a receiving portion 66 having an appropriate depth. A dentist can check the shape of the temporomandibular joint of a patient with CT so that it is sufficient for a dental technician to select the receiving portion 66 having a shape close to the shape of the fossa mandibularis of the patient. Imitating the shape of the temporomandibular joint of the patient allows the hinge axis to be easily reproduced.

Further, the upper bow portion 62 and the lower bow portion 63 are configured to be fixed by a pulling spring 67. The upper bow portion 62 and the lower bow portion 63 are fixed by the pulling spring 67 so that reflex of masticatory movement can be reproduced. The masticatory movement is voluntary movement. However, in the same manner as other movements brought about by skeletal muscles, small corrections are performed by involuntary movement brought about by reflex. The upper bow portion 62 and the lower bow portion 63 are fixed by the pulling spring so that it is possible to reproduce the reflex caused by the stimulation of an occlusal pressure generated at the time of mastication. Since it is possible to imitate the shape of the temporomandibular joint and the movement of the muscle, it is possible to automatically apply freedom in centric to a prosthesis.

Further, transparent position check guides 68 are prepared, and are allowed to be disposed on the outside of the struts. Accordingly, a prosthesis can be produced while the horizontal position and the vertical position are checked using the position check guide 68.

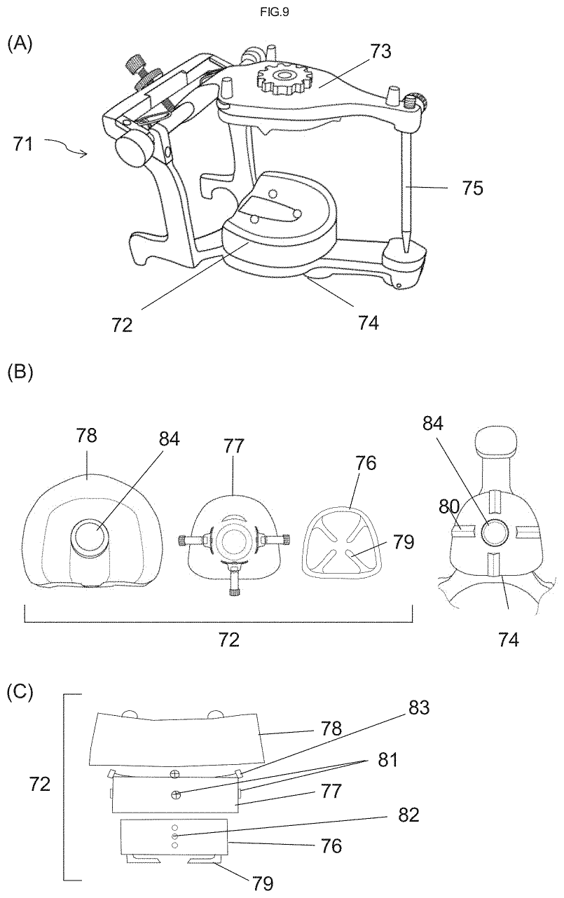

An articulator 71 is configured such that a mandible mounting plate 72 is movable. It is devised that the mandible mounting plate 72 is allowed to reproduce the rotation and pendulum motion of the mandible defined by Monson's spherical theory (FIG. 9). The mandible mounting plate 72 can be attached to an existing articulator.

The description is made with respect to an articulator where the mandible mounting plate 72 is attached to the articulator 71 which equips an upper bow portion 73, a lower bow portion 74, and an incisal pin 75. However, the mandible mounting plate 72 may be attached to an articulator of any type which equips a lower bow portion.

The mandible mounting plate 72 is configured to be movable in the vertical direction and the lateral direction by screws to cope with rotation and pendulum motion. The mandible mounting plate 72 is formed of a mounting plate lower portion 76 used in a state of being fixed to the lower bow portion 74, a movable portion 77, and a mounting plate upper portion 78 (FIG. 9(B)).

FIG. 9(B) shows the plan view of the mounting plate lower portion 76 and the movable portion 77 as viewed from above, and the plan view of the mounting plate upper portion 78 as viewed from below. With respect to the mounting plate lower portion 76, leg portions 79 are disposed in a space in a rotation preventing mechanism 80 of the lower bow portion, and are fixed to the lower bow portion 74 by plaster.

As shown in FIG. 9(C), screws 81 are provided to the movable portion 77 at four portions in a median direction and a direction orthogonal to the median direction, and the screws 81 are threadedly engaged with screw holes 82 formed in the mounting plate lower portion 76. A plurality of screw holes 82 are provided so that the height and inclination can be adjusted by correcting the positions of the screws and the screw holes at four portions. Further, after a position is corrected by a screw 83, the mounting plate upper portion 78 is fixed on the movable portion 77 by a fixing magnet 84. It is sufficient that one side of the fixing magnet 84 is formed of a magnet so that the other side of the fixing magnet 84 may be formed of a metal sheet. Appropriate height and inclination are given to the mandible mounting plate 72 by the movable portion 77 so that the rotation and pendulum motion of the mandible defined by Monson's spherical theory can be easily reproduced.

The articulator 71 can reproduce the movement of the temporomandibular joint and hence, a prosthesis can be produced in a state where long centric or wide centric is given between the centric position and the maximal intercuspal position.

### REFERENCE SIGNS LIST

1, 2, 3, 5, 7, 8, 9, 10, 13, 21, 31, 41, 51 . . . occlusion recording instrument, 4, 25 . . . small hole, 6, 22 . . . holding portion, 11, 12, 23a, 23b . . . protruding portion, 14, 26 . . . protruding portions/recessed portions, 15, 28 . . . maintaining hole, 24 . . . flat plate portion, 27 . . . flat plate member, 32, 42 . . . fitting member, 33, 43, 52 . . . bite plane, 34, 44 . . . fixture fitting portion, 35, 45, 54 . . . protrusion, 36, 46 . . . outer edge portion, 37, 47 . . . fitting protrusion, 38, 48 . . . joint portions, 53 . . . fixture fitting flat plate member, 55 . . . bite plane protrusion, 56 . . . through hole, 61, 71 . . . articulator, 62, 73 . . . upper bow portion, 63, 74 . . . lower bow portion, 64 . . . strut, 65 . . . upper bow support portion, 66 . . . receiving portion, 67 . . . pulling spring, 68 . . . position check guide, 72 . . . mandible mounting plate, 75 . . . incisal pin, 76 . . . mounting plate lower portion, 77 . . . movable portion, 78 . . . mounting plate upper portion, 79 . . . leg portion, 80 . . . rotation preventing mechanism, 81, 83 . . . screw, 82 . . . screw hole, 84 . . . fixing magnet, A . . . fixture

1-7. (canceled)

8. An occlusion recording instrument which performs occlusal registration after an occlusal vertical dimension is determined, wherein
the occlusion recording instrument is made of a hard material,
the occlusion recording instrument has a length of a mesiodistal distance which requires prosthetic treatment, and
the occlusion recording instrument has a flat plate shape, or includes a protruding portion.

9. The occlusion recording instrument according to claim 8, wherein
the occlusion recording instrument having the flat plate shape is configured such that an occlusal vertical dimension is adjustable by selecting a thickness of the occlusion recording instrument or by making the occlusion recording instruments overlap with each other, and
the occlusion recording instrument equipping the protruding portion is configured such that an occlusal vertical dimension is adjustable by machining the protruding portion, or by adding a resin.

10. The occlusion recording instrument according to claim 8, wherein the occlusion recording instrument is capable of being cut corresponding to a mesiodistal distance which occlusal registration requires.

11. The occlusion recording instrument according to claim 9, wherein the occlusion recording instrument is capable of being cut corresponding to a mesiodistal distance which occlusal registration requires.

12. The occlusion recording instrument according to claim 8, further comprising a holding portion configured to be held by an articulating paper holder and/or tweezers.

13. The occlusion recording instrument according to claim 9, further comprising a holding portion configured to be held by an articulating paper holder and/or tweezers.

14. The occlusion recording instrument according to claim 10, further comprising a holding portion configured to be held by an articulating paper holder and/or tweezers.

15. An articulator comprising:
an upper arch portion configured to support a maxilla model;
a lower arch portion configured to support a mandible model; and
a strut configured to support an upper arch, wherein
the strut equips an upper arch support portion, which comes into contact with the upper arch portion or the lower arch portion, at an end portion of the strut,
the upper arch portion and the lower arch portion equip a receiving portion which comes into contact with the upper arch support portion,
the upper arch support portion has a shape imitating a condyle of a patient,
the receiving portion has a shape imitating a fossa mandibularis, and
the receiving portion is configured to be replaceable corresponding to the shape of the mandible of the patient.

16. The articulator according to claim 15, wherein
the upper arch portion and lower arch portion are fixed by a pulling spring.

17. An articulator comprising:
an upper arch portion configured to support a maxilla model;
a lower arch portion configured to support a mandible model; and
a maxilla mounting plate and a mandible mounting plate, wherein
the mandible mounting plate is configured to be movable so as to allow the mandible mounting plate to apply movement similar to rotation and pendulum motion defined by Monson's spherical theory.
